(19) United States
(12) Patent Application Publication
(10) Pub. No.: US 2002/0062202 A1
(43) Pub. Date: May 23, 2002

(54) Image data acquisition method

(75) Inventor: Yujin Arai, Tokyo (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Olympus Optical co., Ltd., Tokyo (JP)

(21) Appl. No.: 09/955,858

(22) Filed: Sep. 19, 2001

(30) Foreign Application Priority Data
Sep. 21, 2000 (JP) 2000-287618

(51) Int. Cl. G06F 19/00

(52) U.S. Cl. 702/127; 702/19

(57) ABSTRACT

An image data acquisition method comprises scanning a sample by a light, receiving a light from the sample, to acquire a scanned image data, and storing the scanned image data obtained by scanning a region of a predetermined size every time a region scanned by the light reaches a predetermined size, sequentially.

### CROSS-REFERENCE TO RELATED APPLICATION

This application is based upon and claims the benefit of priority from the prior Japanese Patent Application No. 2000-287618, filed Sep. 21, 2000, the entire contents of which are incorporated herein by reference.

### BACKGROUND OF THE INVENTION

1. Field of the Invention

The present invention relates to an image data acquisition method for scanning a sample such as a DNA (microarray (DNA chip), for example, by light beams in a two-dimensional manner, and measuring reflection light, transmission light, scattered light or fluorescence from the sample, thereby acquiring scanned image data.

2. Description of the Background Art

In recent years, there has been introduced a DNA microarray technique as means for implementing a large amount of gene expression and analysis within a short time. In this DNA microarray, solution containing a gene DNA is dropped by some nanoliters on a substrate such as a slide glass, a stain-like spot of some tens to 100 microns in diameter is formed, and these stops are regularly arrayed in some thousands to some ten thousands points on a substrate.

On such a DNA microarray, an RNA being a sample is distributed after labeled by fluorescence, and is washed, and fluorescence generated by emitting laser light to each spot is measured. A gene expression can be analyzed by a fluorescence intensity.

A scanning type optical measuring device called a DNA microarray reader is used for measuring fluorescence during this gene expression and analysis. A configuration of this scanning type optical measuring device is similar to that of a general confocal laser microscope. That is, the laser light emitted from a laser light source is irradiated onto a DNA microarray 3 through an objective lens. The fluorescence generated by irradiation of this laser light is guided to a photoelectric conversion element such as photo multiplier tube (PMT) through a confocal pinhole. Then, a fluorescence intensity is converted into an electrical signal by this photoelectric conversion element.

At this time, the DNA microarray 3 is placed on an electrically driven scanning stage, and is moved in an XY direction. Therefore, the DNA microarray 3 is scanned by the laser light emitted from the laser light source in the XY direction, and the electrical signal outputted from the photoelectric conversion element at this time is transmitted to an image processing device comprising a computer or the like. This image processing device A/D converts the electrical signal from the photoelectric conversion element, and acquires scanned image data.

The scanned image data thus acquired is temporarily stored in a storage medium such as a hard disk as general-purpose image data such as Tagged Image File Format (TIFF) or Bit Map format after all of desired regions set before starting measurement have been scanned. Then, the temporarily stored data is read out by dedicated analysis software, and desired data processing is done, whereby analysis data is obtained.

As a scanning type optical measuring device having its similar function, for example, a laser scanning type cytometer is disclosed in Japanese Patent Application KOKAI Publication No. 8-114540. This laser scanning type cytometer scans cell groups that are interspersed in random on a slide glass by laser light. A signal light such as reflection light, transmission light, scattered light or fluorescence from the cell group at this time is measured, and scanned image data is acquired. This statistic data indicating immunological characteristics and genetic characteristics of the cell group is computed from this scanned image data.

A configuration of this laser scanning type cytometer is similar to a scanning type optical measuring device called the above DNA microarray reader except that main scanning is optically carried out by utilizing a galvano mirror or the like.

On the other hand, a method of acquiring scanned image data is executed as follows. Every time each scanning image of a predetermined region size (hereinafter, referred to as a strip) is acquired, image processing relevant to such scanning image is carried out, thereby recognizing cells acquired by each strip. Then, analysis data such as area, fluorescence intensity, and total fluorescence quantity for individual cells are sequentially computed.

When scanning in all of the predetermined ranges has been competed, statistic data is computed from analysis data on all the acquired cells. Scanned image data is used for calculating the above analysis data. Therefore, the scanned image data is discarded immediately when data analysis completes. In this respect, a laser scanning type cytometer is different from the above DNA microarray reader.

As a device for imaging a wide range of samples such as a cell group on a slide glass, a method of utilizing a laser scanning type microscope, for example, is disclosed in Japanese Patent Application KOKAI Publication No. 10-333056. A configuration of this laser scanning type microscope is different from that of the above DNA microarray reader in that two-dimensional scanning is optically carried out by using a galvano mirror. In addition, the laser scanning type microscope is different from the laser scanning type cytometer in that sub-scanning can be optically carried out, and a confocal optical system is provided.

A method of acquiring scanned image data is carried out as follows. When scanned image data in one field of view is acquired by optical two-dimensional scanning, an electrically driven scanning stage is moved, and goes to the adjacent region. Further, scanned image data in one field of view at the object region is acquired by optical two-dimensional scanning. By repeating this, a plurality of partial scanned image data are acquired relevant to a predetermined region. Then, respective partial scanned image data are strung, and scanned image data in all regions is acquired to be stored in a storage medium.

Of the above methods of acquiring scanned image data, the DNA microarray reader carries out two-dimensional scanning by an electrically driven scanning stage, thus making it possible to scan a wide range. However, a scanning speed is slower by some tens times as compared with another optical scanning method. Thus, a couple of minutes to some tens of minutes is required for scanning all of the regions of some tens of millimeters in square. Therefore, scanned image data cannot be obtained from the start to the end of scanning, and thus, analysis data cannot be obtained in real time.

The laser scanning type cytometer acquires one item of scanned image data, and sequentially carries out image processing every time each strip is scanned. Therefore, the real time properties of analysis data that is problematic in DNA microarray reader can be solved. However, scanned image data is discarded when image processing is carried out, and analysis data is computed. Therefore, the scanned image data on each strip or scanned image data on all the scanning regions cannot be acquired or stored.

There is provided a problem that the laser scanning type cytometer cannot carry out analysis processing precisely when cells targeted for measurement exist across the boundary of strips, or alternatively, cannot recognize the cells. When the DNA microarray is measured by a similar method, the precision of a spot position differs depending on a spot generating device, and thus, there is a possibility that a spot position at an end of one strip comes out of a scanning region.

In an example utilizing a scanning laser microscope, partial images are sequentially acquired, and scanned image data in all the scanning regions is finally acquired. However, it is presumed that partial image data is shared with another task or program, and thus, analysis processing cannot be carried out until final scanned image data in all the regions has been stored in a recording medium. Further, each item of the partial image data is fixed, and thus, there is a possibility that a measurement object is spanned at the boundary section of partial image data in the same way as when the laser scanning type cytometer is used. Therefore, when only partial image data is analyzed, precious result cannot be obtained.

### BRIEF SUMMARY OF THE INVENTION

It is an object of the present invention to provide an image data acquisition method for analyzing a scanning time relevant to a sample and scanned image data from scanning relevant to the sample, thereby making it possible to minimize a time for computation of the analysis data.

The image data acquisition method according to the present invention is characterized by comprising: scanning a sample by a light; receiving a light from the sample, to acquire a scanned image data; and storing the scanned image data obtained by scanning a region of a predetermined size every time a region scanned by the light reaches a predetermined size, sequentially.

In the above image data acquisition method, preferable manners are as follows. The manners each may be applied independently, and may be applied in combination as required.

(1) The size of the scanned region by the light is changed according to an arrangement position thereof when a plurality of measurement objects are arranged in the sample.

(2) In (2), position information on respective scanning regions is stored to be added to each item of the scanned image data sequentially stored.

(3) In (2), the sample is a DNA microarray in which a number of spots are arranged as a measurement object, and the size of the scanning region is such that a boundary in the scanning region is not overlapped on the spot.

(4) In (2), the scanning by the light is carried out by main scanning and sub-scanning in a direction orthogonal thereto, and adjustment of the size of the scanning region is carried out by regulating the number of scanning lines of the main scanning.

(5) An analysis processing is executed for the stored scanned image data in parallel with scanning of a next region when the storage of the scanned image data completes.

(6) In (5), the sample is a DNA microarray in which a number of spots are arranged as a measurement object, and the size of the scanning region is such that a boundary in the scanning region is not overlapped on the spot.

(7) The scanning by the light is carried out by main scanning and sub-scanning in a direction orthogonal thereto, and both of the main scanning and the sub-scanning are carried out by moving the sample.

(8) The scanning by the light is carried out by main scanning and sub-scanning in a direction orthogonal thereto, and the main scanning is carried out by an optical scanner.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a configuration of a scanning type optical measuring device to which an image data acquisition method according to a first embodiment of the present invention is applied;

FIG. 2 is a diagram showing a configuration of a data processing device in a scanning type optical measuring device to which the image data acquisition method according to the first embodiment of the present invention is applied;

FIG. 3 is a view showing laser light scanning and one strip on a DNA microarray in a scanning type optical measuring device to which the image data acquisition method according to the first embodiment of the present invention is applied;

FIG. 4 is an external view of a DNA microarray to be measured by an image data acquisition method according to a second embodiment of the present invention;

FIG. 5A and FIG. 5B are enlarged views when a spot line on the DNA microarray to be measured by the image data acquisition method according to the second embodiment of the present invention is spanned at a boundary section of strips;

FIG. 6A and FIG. 6B are enlarged views when a partial spot on the DNA microarray to be measured by the image data acquisition method according to the second embodiment of the present invention is spanned among a strip;

FIG. 7 is a graph illustrating data acquisition when a spot line is spanned at the boundary section of strips in the image data acquisition method according to the second embodiment of the present invention; and

FIG. 8 is a graph illustrating data acquisition when a partial spot is spanned at the boundary section of strips in the image data acquisition method according to the second embodiment of the present invention.

### DETAILED DESCRIPTION OF THE INVENTION

Hereinafter, preferred embodiments of the present invention will be described with reference to the accompanying drawings.

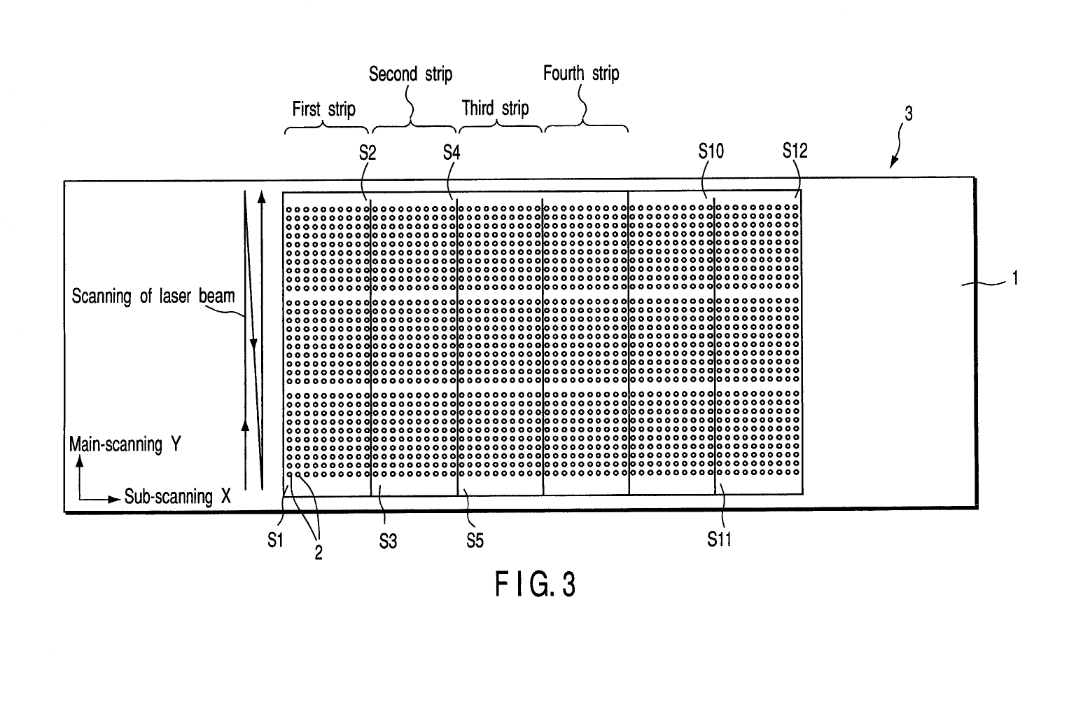

FIG. 1 is a view showing a configuration of a scanning type optical measuring device to which an image data acquisition method according to the present invention is applied. A DNA microarray 3 shown in FIG. 3 that will be described later in detail, for example is placed on an electrically driven XY scanning stage 10.

A collimator lens 13 and an optical path division element 14 comprising a dichroic mirror are disposed on an optical path for laser light 12 outputted from a laser light source 11. The optical path division element 14 has a characteristic that reflects the laser light 12 outputted from the laser light source 11 and transmits fluorescence generated in the DNA microarray 3. An objective lens 16 is disposed on a reflection light path of the optical path division element 14 via a lens 5. A photoelectric conversion element 18 using a photoelectric multiplexing tube (PTM) is disposed on a transmission optical path of the florescence from the DNA microarray 3 via a lens 17. The photoelectric conversion element 18 converts incident fluorescence into an electrical signal according to its light intensity, and transmits the converted electrical signal to a data processing device 19.

An optical scanner such as a galvano mirror is inserted on the optical path from the objective lens 16 to the optical path division element 14, whereby main scanning of the laser light 12 may be optically carried out instead of the electrically driven XY scanning stage 10. In addition, main scanning may be carried out by using a plurality of laser light sources and photoelectric conversion elements so as to correspond to a variety of label pigments.

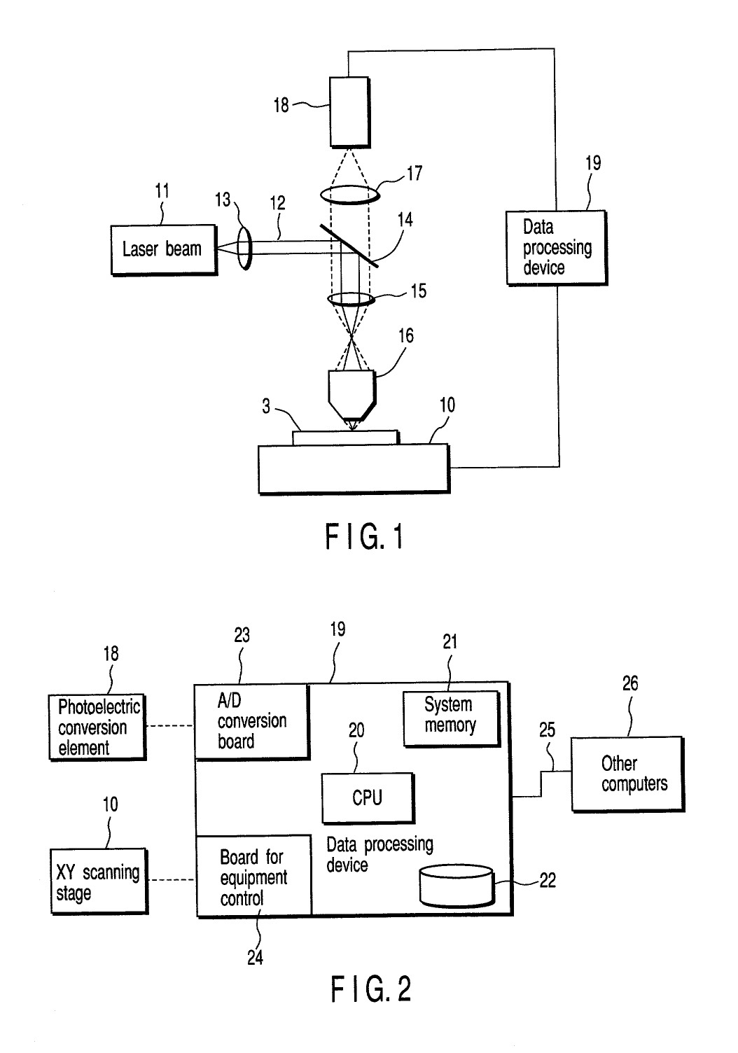

FIG. 2 is a diagram showing a configuration of a data processing device 19. The data processing device 19 comprises a CPU 20, a system memory 21, a storage medium 22, an A/D conversion board 23, and a board for equipment control 24. The system memory 21 stores data acquisition software using an image data acquisition method according to the present invention. In addition, the system memory 21 forms a unshared memory for temporarily storing data captured and collected from the A/D conversion board 23 (digital electrical signal from the photoelectric conversion element 18).

The storage medium 22 comprises a hard disk or the like for filing a digital electrical signal stored in the unshared memory in the system memory 21, and storing the filed signal as scanned image data.

The A/D conversion board 23 digitizes the electrical signal from the photoelectric conversion element 18.

The board for equipment control 24 outputs an XY scanning control signal to the electrically driven XY scanning stage 10.

The data processing device 19 can be connected to another computer 26 via a network 25. The computer 26 analyzes and processes the scanned image data stored in the storage medium 22. Use of the computer 26 reduces a burden of the CPU 20 in the data processing device 19.

The CPU 20 executes the data acquisition software stored in the system memory 21, and outputs the XY scanning control signal to the electrically driven XY scanning stage 10 through the board for equipment control 24. Then, laser light is scanned on the DNA microarray. FIG. 3 is a view showing a DNA microarray and laser light scanning and one strip on the DNA microarray. As shown in FIG. 3, a stain-like spot 2 of about some tens to hundreds of microns in diameter formed by dropping or applying solution containing a genetic DNA by some nanoliters is regularly arranged in some thousands to some ten thousands of points.

Scanning of the laser light 12 is defined such that a Y scanning direction is a main scanning and an X scanning direction is a sub-scanning in the specification.

The CPU 20 executes the data acquisition software stored in the system memory 21, receives fluorescence from a plurality of the spots 2 when the laser light 12 is scanned on the DNA microarray 3, and acquires scanned image data. At this time, the CPU sequentially stores in the storage medium 22 the scanned image data obtained every time the scanning region of the laser light 12 reaches a region of a predetermined size, for example, one strip, i.e., when scanning of each of the strips, i.e., first strip, second strip, and third strip completes.

Now, an operation of the device configured as described above will be described here.

The laser light 12 outputted from the laser light source 11 is incident to the optical path division element 14 through the collimator lens 13, is reflected by the optical path division element 14, and is emitted to the DNA microarray 3 via from the lens 15 to the objective lens 16.

At this time, the DNA microarray 3 is scanned by the laser light under the control of the CPU 20.

When the DNA microarray 3 is scanned by the laser light 12, the fluorescence emitted from the DNA microarray 3 transmits from the objective lens 16 to the lens 15 and the optical path division element 14, and is focused on the photoelectric conversion element 18 by the lens 17.

The photoelectric conversion element 18 converts the incident fluorescence into an electrical signal according to its light intensity, and outputs the converted signal to the data converting device 19.

The CPU 20 starts scanning by the laser light 12 from a predetermined scanning start point S1. When the laser light reaches a point S2, one strip is completed.

The number “n” of scanning lines of the first strip from the scanning start point S1 to the point S2 is determined by the number “s” of capture lines of the spot 2 in one strip, a distance D between the respective spots 2, and a scanning interval “d”, and is assigned by the formula below.

n=s·D/d (1)

For example, when spots 2 arranged at intervals of 200 microns are captured in 10 lines in one strip by scanning laser light 12 at intervals of 5 microns, the number of scanning lines is 400.

The CPU 20 temporarily stores data captured in the A/D conversion board 23 (electrical signal produced by digitizing an analog signal from the photoelectric conversion element 18) in the unshared memory in the system memory 21. When the CPU 20 acquires data in number of scanning lines for the first strip shown in FIG. 3, the CPU files the digital electrical signal stored in the unshared memory, and stores the filed signal as scanned image data in the storage medium 22.

Next, the CPU 20 starts scanning by the laser light 12 from a point S3, and temporarily stores the electrical signal from the photoelectric conversion element 18 in the unshared memory in the system memory 21 until the laser light has reached a point S4. Then, when the CPU 20 acquires data in number of scanning lines for the second strip shown in FIG. 3 after scanning of the laser light 12 has reaches the point S4, the CPU files the digital electrical signal stored in the unshared memory, and stores the filed signal in the storage medium 22 as new scanned image data.

Subsequently, each item of the scanned image data for each strip is stored in the storage medium 22. When scanning of the laser light 12 reaches a point S12, the CPU 20 completes scanning for all regions relevant to the DNA microarray 3.

On the other hand, the CPU 20 stores in the storage medium 22 each item of the scanned image data on each strip such as a first strip, a second strip, and a third strip, and executes analysis processing for these items of the scanned image data.

In this way, in the first embodiment, when fluorescence from a plurality of the spots 2 is received, and scanned image data is acquired when the laser light 12 is scanned on the DNA microarray 3, every time the scanning region of the laser light 12 reaches one strip, items of scanned image data each obtained by scanning such one strip are sequentially stored in the storage medium 22. Therefore, a multi-task compatible operation system is employed for the data processing device 19. Then, data acquisition software and image processing software are initiated, and every time new scanned image data is produced in a specified directory, the image processing software is set so as to operate. In this manner, every time each item of the scanning data on each strip such as the first strip, second strip, and third strip is produced, analysis data can be sequentially obtained.

Therefore, a required time between scanning for each spot 2 on the DNA microarray 3 and analysis of scanned image data from scanning for each of the spots 2, followed by computing the analysis data can be minimized.

A second embodiment of the present invention will be described with reference to the accompanying drawings. A configuration of a scanning type optical measuring device to which the image data acquisition method according to the present invention is applied is identical that shown in FIG. 1 and FIG. 2. Here, a description of the difference elements will be given below.

A CPU 20 executes data acquisition software stored in a system memory 21, thereby changing a size of one strip for scanning laser light 12 according to an arrangement position of a plurality of spots 2 on a DNA microarray 3.

In addition, the CPU 20 executes the data acquisition software stored in the system memory 21, thereby adding scanning position information for items of scanned image data each sequentially stored in a storage medium 22.

In addition, the CPU 20 executes the data acquisition software stored in the system memory 21, thereby storing scanned image data and executing analysis processing for the scanned image data.

In the meantime, the DNA microarray 3 is produced by dropping solution containing a genetic DNA as described above on a substrate 1 such as a base processed slide glass. Thus, each spot 2 is not always formed in a true circle, and may extend off the line of the spot 2 significantly. In addition, a displacement between a position of the spot 2 and a scanning start position may occur, and spot intervals may be not constant. In such a case, the spot 2 is spanned at the boundary of respective strips.

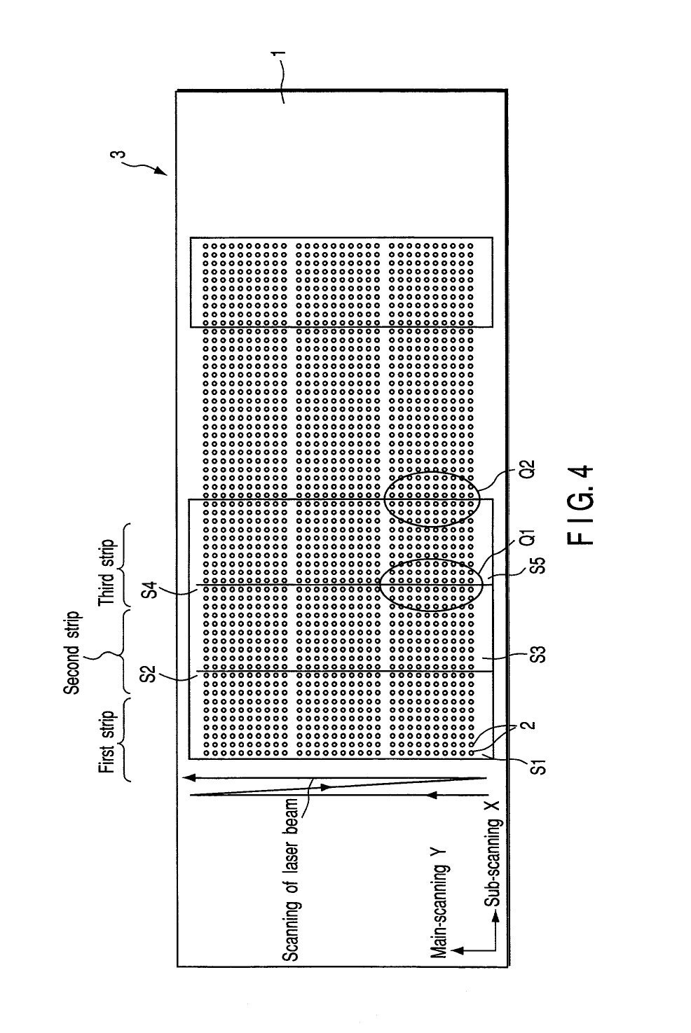

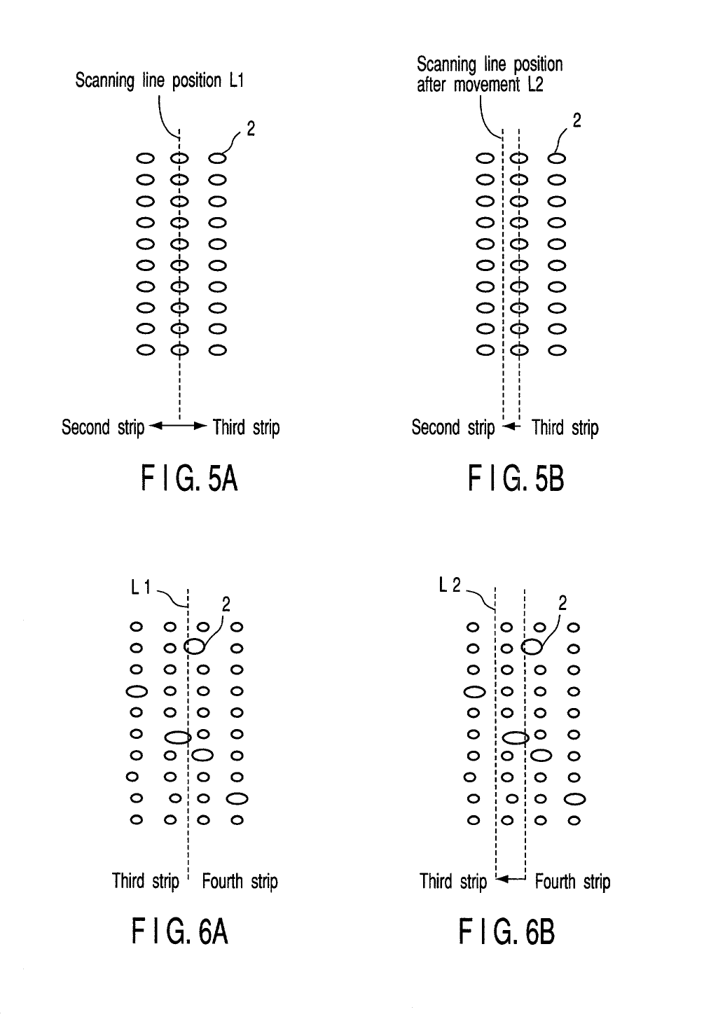

FIG. 4 is a an external view of a DNA microarray 3 in the above case. In FIG. 4, a boundary section between a first strip and a second strip is included in intervals for spot lines, and the spot 2 is included without being spanned in the strip. However, at a boundary section between the second strip and a third strip, as shown in FIG. 5A, a stop line is spanned in the strip boundary section. Alternatively, at a boundary section between the third strip and a fourth strip, as shown in FIG. 6A, a partial spot 2 is spanned between the strips.

In such a case, the CPU 20 executes the data acquisition software stored in the system memory 21, thereby adjusting the number of scanning lines for the laser light 12 as required so that the spot 2 is not broken by the strip boundary section according to the arrangement position of a plurality of the spots 2 on the DNA microarray 3. Then, the CPU 20 changes the size of one strip for scanning the laser light 12, i.e., acquires scanned image data in proper image size, and stores the acquired data in the storage medium 22. The CPU 20 continuously acquires the next scanned image data so as to be continuous with the acquired scanned image data by immediately preceding scanning.

A specific processing operation will be described. (a) In a case (FIG. 5A) where a spot line is spanned at a strip boundary section as in the boundary section between the second strip and the third strip (a portion Q1 shown in FIG. 4)

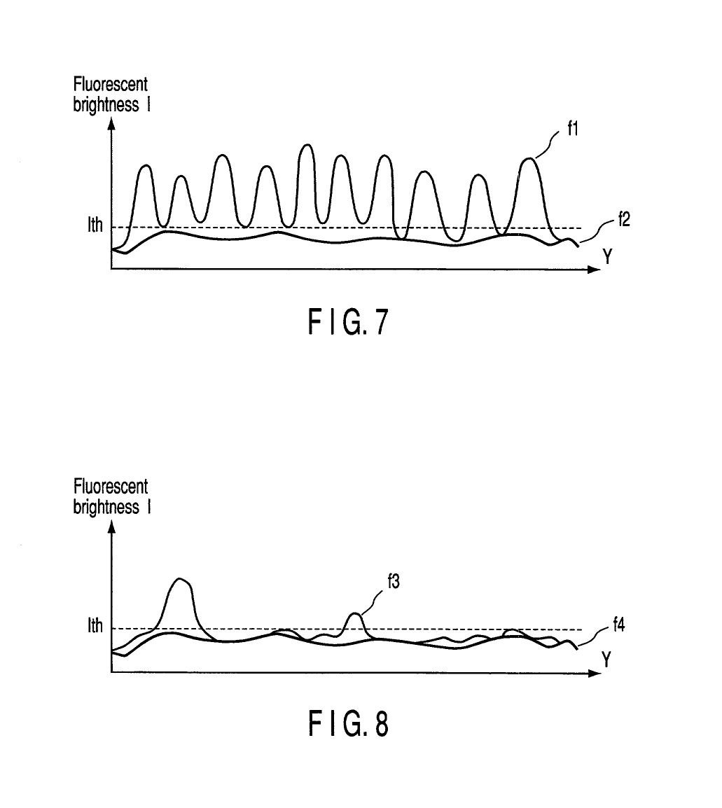

The CPU 20 acquires the number of scanning lines set for one strip, and completes acquisition of data for one strip. At this time, it is assumed that a last scanning line position L1 is set a substantial center of a spot line as shown in FIG. 5A. When a fluorescence intensity 1 on this last scanning line is obtained, a distribution f1 is obtained such that the luminescence is increased for each spot 2 as shown in FIG. 7. In FIG. 7, the fluorescence intensity I is defined on a vertical axis, and a main scanning direction (Y direction) is defined in a horizontal axis.

The CPU 20 returns the scanning line position L1 along a sub-scanning direction (X direction) as shown in FIG. 5B until thresholds in all the pixels have been lower than a predetermined threshold “Ith”. Then, a last scanning line position L2 for one strip moves between spot lines as shown in FIG. 5B, and the fluorescence intensity I is obtained as a distribution f2 as shown in FIG. 7.

Here, the CPU 20 sets the last scanning line position to the scanning line position L2 after movement, as shown in FIG. 5B. That is, the position L2 is recognized as a boundary section between the second strip and the third string. Then, scanned image data on the number of scanning lines fewer than a predetermined number of scanning lines is stored in the storage medium 22.

At this time, the CPU 20 adds to a header section of scanned image data the scanning position information for each item of scanned image data, for example, the number of scanning lines in a second strip, a position coordinate when the second strip starts and ends, an integrated scanning line number from the first scanning line or the like, and stores the data in the storage medium 22.

(b) In a case (FIG. 6A) where a partial spot 2 is spanned between strips as in the boundary section between the third strip and the fourth strip (portion Q2 shown in FIG. 4)

The CPU 20 acquires the number of scanning lines set for one strip, and completes acquisition of data for one strip. At this time, it is assumed that the last scanning line position L1 is spanned at the boundary section between the third strip and the fourth strip as shown in FIG. 6A. When the fluorescence intensity I on the last scanning line is obtained, a distribution f3 is obtained such that the intensity at the portion of the spot 2 spanned between strips is increased as shown in FIG. 8.

The CPU 20 returns the scanning line position L1 along the sub-scanning direction (X direction) as shown in FIG. 6B until the thresholds in all the pixels have been lowered than a predetermined threshold “Ith”. By doing so, the last scanning position L2 for one strip moves to a position at which the position does not pass through which the spot 2 spanned between the strips as shown in FIG. 6B, and the fluorescence intensity I is obtained as a distribution f4 as shown in FIG. 8.

Here, the CPU 20 sets the last scanning position to the last scanning line position L2 after movement, as shown in FIG. 6B. That is, this position L2 is recognized as the boundary section between the third strip and the fourth strip. Then, scanned image data on the number of scanning lines fewer than a predetermined number of scanning lines is stored in the storage medium 22.

At this time, the CPU 20 adds to a header section of scanned image data the scanning position information for each item of scanned image data, for example, the number of scanning lines in a third strip, a position coordinate when the third strip starts and ends, an integrated scanning line number from the first scanning line or the like, and stores the data in the storage medium 22.

In this way, in the second embodiment, the size of each strip scanning the laser light 12 is changed according to the arrangement position of a plurality of the spots 2 on the DNA microarray 3. Therefore, in addition to an effect according to the first embodiment, even when the spot 2 is not always formed in a perfect circle, as the case may be, the spot significantly comes out of the line of the spots 2, or a displacement between a position of spot 2 and a scanning start position occurs, or alternatively, spot intervals are not constant, and the spot 2 is spanned at the boundary between the strips, scanned image data can be stored without cutting the spot 2.

The CPU 20 adds the scanning position information to the scanned image data stored in the storage medium 22, thus making it possible to obtain an absolute position of each spot 2 on the DNA microarray 3.

Although the above described embodiments each have described the present invention by way of example when the image data acquisition method according to the present invention is applied to a DNA microarray reader, the present invention is applicable to a laser scanning type microscope, for example, without being limited thereto.

In addition, although the above described embodiments each have described a mode in which laser light scanning is carried out for a substrate 1 once in a main scanning direction (Y direction), the main scanning direction may be divided into three sections A, B, and C, for example, in FIG. 3. In this way, the size of each scanning region can be arbitrarily set.

According to the present invention, there can be provided an image data acquisition method capable of minimizing a time between scanning for samples and analyzing scanned image data from the scanning for samples, followed by computing the analysis data.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image data acquisition method comprising:
scanning a sample by a light;
receiving a light from the sample, to acquire a scanned image data; and
storing the scanned image data obtained by scanning a region of a predetermined size every time a region scanned by the light reaches a predetermined size, sequentially.

2. The image data acquisition method according to claim 1, wherein, the size of the scanned region by the light is changed according to an arrangement position thereof, when a plurality of measurement objects are arranged in the sample.

3. The image data acquisition method according to claim 2, wherein position information on respective scanning regions is stored to be added to each item of the scanned image data sequentially stored.

4. The image data acquisition method according to claim 2, wherein the sample is a DNA microarray in which a number of spots are arranged as a measurement object, and the size of the scanning region is such that a boundary in the scanning region is not overlapped on the spot.

5. The image data acquisition method according to claim 2, wherein the scanning by the light is carried out by main scanning and sub-scanning in a direction orthogonal thereto, and adjustment of the size of the scanning region is carried out by regulating the number of scanning lines of the main scanning.

6. The image data acquisition method according to claim 1, wherein an analysis processing is executed for the stored scanned image data in parallel with scanning of a next region when the storage of the scanned image data completes.

7. The image data acquisition method according to claim 6, wherein the sample is a DNA microarray in which a number of spots are arranged as a measurement object, and the size of the scanning region is such that a boundary in the scanning region is not overlapped on the spot.

8. The image data acquisition method according to claim 1, wherein the scanning by the light is carried out by main scanning and sub-scanning in a direction orthogonal thereto, and both of the main scanning and the sub-scanning are carried out by moving the sample.

9. The image data acquisition method according to claim 1, wherein the scanning by the light is carried out by main scanning and sub-scanning in a direction orthogonal thereto, and the main scanning is carried out by an optical scanner.
